(19) United States
(12) Patent Application Publication
(10) Pub. No.: US 2024/0412119 A1
(43) Pub. Date: Dec. 12, 2024

(54) METHOD FOR CENTRALIZED UPDATING OF PRICES AND AVAILABILITY OF HOTEL ROOMS

(71) Applicant: AMADEUS S.A.S., Biot (FR)

(72) Inventors: Marc TRAINA, Biot (FR); Gregory VALIGIANI, Biot (FR); Philippe SARCEY, Biot (FR); Yoann POULAIN, Biot (FR); Franck LESIEUR, Biot (FR); Sebastien ROCHE, Biot (FR); Vigneshwari PANDIARAJ, Chennai (IN); Aditya Vikram DUGGAL, Haryana (IN)

(21) Appl. No.: 18/741,044

(22) Filed: Jun. 12, 2024

(30) Foreign Application Priority Data
Jun. 12, 2023 (FR) 2305904

(51) Int. Cl. G06Q 10/02; G06F 16/23; G06Q 10/087; G06Q 30/0201; G06Q 50/12

(52) U.S. Cl. CPC G06Q 10/02; G06F 16/2358; G06Q 10/087; G06Q 30/0206; G06Q 50/12

(57) ABSTRACT

An aspect of the invention relates to a method for centrally updating inventory of electronic provider objects comprising:
merging a plurality of object changes from a first queue by change category; for each change category, determining an impact of the merged object changes on a set of data pairs in a general database, each data pair being formed by two given attributes of an electronic provider object placing each impacted data pair in a second queue; determining, for each impacted data pair, an update of the two given attributes of an electronic provider object over a second predetermined period via a query to the general database.

### TECHNICAL FIELD

The present invention relates to a method for centralized updating of inventory

### BACKGROUND

Updating inventory, for example of electronic provider objects, can be challenging as there are many vectors for distributing such electronic provider objects.

In one example of electronic provider objects, reservation centers of the largest hotel chains process up to several tens of thousands of messages per second, typically 5000 messages per second, for example to distribute electronic provider objects provided by such reservation centers. This figure is constantly increasing, due to the development of on-line distribution channels, in particular on-line travel agencies and offer comparison sites.

Central inventory systems of hotel chains usually use a central reservation system, also known as CRS (Central Reservations System), to update and maintain hotel inventory and rate information so that hotels can manage their reservations in real time. These reservations are managed through many distribution channels, such as reservation sites, or offer hubs, also known as GDS (Global Distribution Systems).

Consequently, the ability of the centralized inventory system to quickly send relevant messages, which may provide a vector for distributing electronic provider objects provided by the centralized inventory system, creates a technical problem of managing inventory of such electronic provider objects.

Put another way, in view of the ever-increasing number of messages, current centralized inventory systems do not allow for satisfactory data synchronization.

### SUMMARY

The present specification offers a solution to the above problem by proposing a method for centralized updating of inventory of electronic provider objects that allows satisfactory synchronization of data associated with electronic provider objects.

In this context, the present specification thus relates, in its broadest aspect, to a method, performed by a centralized inventory system, of centrally updating inventory of electronic provider objects, the method comprising
receiving object changes that impact one or more of two given attributes of an electronic provider object;
placing the object changes in a first queue;
merging several object changes from the first queue according to change category (e.g. a type of a change to an electronic provider object);
for each change category, determining an impact of the merged object changes on a set of data pairs from a general database external to the centralized inventory system, each data pair being formed by the two given attributes;
placing each impacted data pair in a second queue;
determining, for each impacted data pair, an update of one or more of the two given attributes over a second predetermined period via a query to the general database;
comparing a hash value of the update of a data pair with a hash value of a corresponding data pair previously stored in a database of the centralized inventory system;
when a difference between the hash value of the data pair update and the hash value of a corresponding data pair is detected, one or more of:
   transmitting the data pair update to an electronic provider object inventory platform; and
   storing the hash value of the data pair update in the database of the centralized inventory system.

The method according to the present specification thus enables detection of all changes to one or more of the two given attributes, which, in the context of electronic provider objects that represent hotel rooms, may include availability or price changes of hotel rooms, and then propagate them to external partners, for example Expedia® or Booking®. Indeed, in this context, the electronic provider object inventory platform may comprise a hotel room inventory platform. The steps of merging multiple object changes from the first queue according to change categories (or types of change) and determining an impact of the merged object changes on a set of data pairs from a general database external to the centralized inventory system together allow for a decrease in the number of queries to be processed by the centralized inventory system. Thus, these steps allow for satisfactory data synchronization, and more specifically, allow for improved scalability.

In addition to the features just mentioned in the preceding paragraph, the method according to this aspect of the present specification may have one or more additional features from among the following, considered individually or in any technically possible combinations.

According to a non-limiting aspect of the present specification, when a difference between the hash value of the update of a data pair and the hash value of a corresponding data pair is detected, the method comprises a step of storing an update indicator in the database of the centralized inventory system.

According to a non-limiting aspect of the present specification, the method may further comprise (e.g. as performed by the centralized inventory system):
Receiving, from the electronic provider object inventory platform, periodically according to a third predetermined period an update request;
If an update flag is stored in the centralized inventory system database, transmitting the update flag to the electronic provider object inventory platform.

According to a non-limiting aspect of the present specification, the step of merging multiple object changes from the first queue by change categories is performed periodically according to a first predetermined period.

According to a non-limiting aspect of the present specification, the first predetermined period may be between 8 and 12 seconds, and may typically be 10 seconds.

According to a non-limiting aspect of the present specification, the second predetermined period may be between 15 days and 45 days.

According to a non-limiting aspect of the present specification, the method may further comprise the preliminary steps of:
performing, via a man-machine interface, object modifications likely to impact one or more of the two given attributes;
compacting, via aggregation means, the object modifications likely to impact one or more of the two given attributes; and
recording the compacted changes in the general database.
   Another aspect of the present specification relates to a computer program product downloadable from a communication network and/or stored on a computer-readable medium and/or executable by a processor, the computer program product being characterized in that it comprises program code instructions for implementing the method according to any of the above aspects of the present specification, when the program is executed on a computer.

A different aspect of the present specification relates to a system for centrally updating an inventory of electronic provider objects, the centralized updating system being characterized in that it includes a memory storing the aforementioned computer program product.

The present specification and its various applications will be better understood upon reading the following description and examination of the accompanying figures.

### BRIEF DESCRIPTION OF THE FIGURES

The figures are illustrative and in no way limiting of the present specification.

FIG. 1 illustrates the steps of a method for centrally updating inventory of electronic provider objects according to a non-limiting aspect of the present specification.

FIG. 2 shows a schematic representation of a centralized inventory system arranged to perform the steps of the process illustrated in FIG. 1.

### DETAILED DESCRIPTION

Unless otherwise specified, the same element appearing in different figures has a unique reference.

As used herein, the term “electronic provider object” may refer to data objects and/or data records which correspond to products and/or items, such as travel-related goods and services (e.g., flights, hotel reservations, train reservations, bus reservations, ship and/or ferry reservations, car rentals and the like), provided by a provider system, which may refer to any system that provides the aforementioned electronic provider objects, and such provider systems may be operated by any suitable entity, such hotel companies, airlines, train companies, bus companies, ship and/or ferry companies, car reservation companies, amongst other possibilities. More specifically, the electronic provider objects discussed in the examples below may specifically represent hotel rooms, but may alternatively represent flight tickets, train tickets, bus tickets, ship and/or ferry reservations, car reservations and the like, amongst other possibilities, and, hence an electronic provider object may have certain related attributes, which may include, but is not limited to, availability and price thereof, including, but not limited to, availability and price of a hotel room. The electronic provider objects may be in any suitable format including, but not limited to Edifact recommendations in the context of Global Distribution System (GDS)-based data exchange, offer records in the context of New Distribution Capability (NDC)-based data exchange, and/or any other suitable format. Indeed, the electronic provider objects may comprise data objects and/or data records, for example stored as an Edifact recommendation or an NDC offer, and/or any other suitable data representing at least one item provided by a provider system. Furthermore, electronic provider objects corresponding to travel may include certain types of electronic provider object identifiers, such as flight numbers, a reservation number, a booking reference number, and the like.

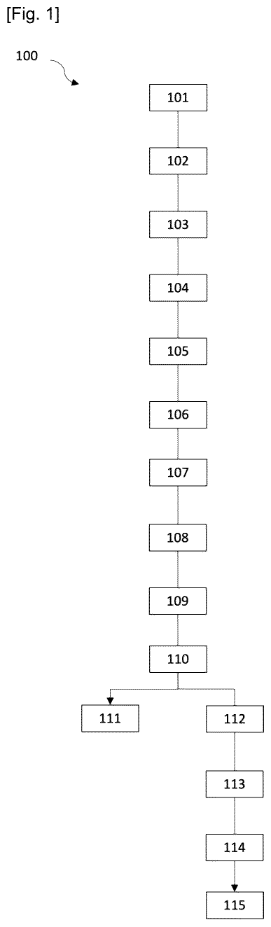

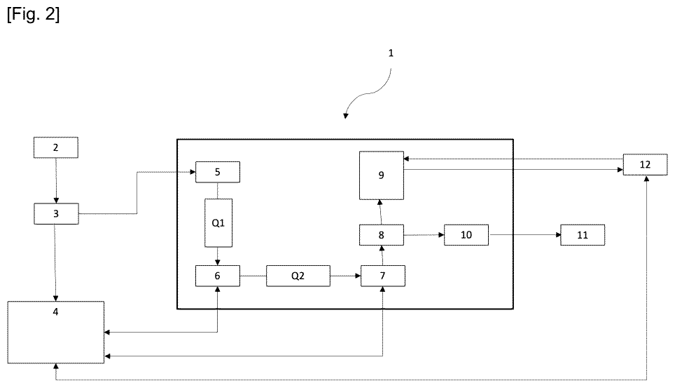

FIG. 1 shows a non-limiting example of a method 100 for centrally updating hotel room prices and availability, and FIG. 2 illustrates a centralized inventory system 1 arranged to perform the steps of the method 100 illustrated in FIG. 1. This centralized inventory system 1 is also known by the acronym CDE (for Change Discovery Engine).

For example, as used herein, the term “engine” refers to hardware (e.g., a processor, such as a central processing unit (CPU), graphics processing unit (GPU), an integrated circuit or other circuitry) or a combination of hardware and software (e.g., programming such as machine-or processor-executable instructions, commands, or code such as firmware, a device driver, programming, object code, etc. as stored on hardware). Hardware includes a hardware element with no software elements such as an application specific integrated circuit (ASIC), a Field Programmable Gate Array (FPGA), a PAL (programmable array logic), a PLA (programmable logic array), a PLD (programmable logic device), etc. A combination of hardware and software includes software hosted at hardware (e.g., a software module that is stored at a processor-readable memory such as random access memory (RAM), a hard-disk or solid-state drive, resistive memory, or optical media such as a digital versatile disc (DVD), and/or implemented or interpreted by a processor), or hardware and software hosted at hardware.

The process 100 comprises a first preliminary step of carrying out 101, via a man-machine interface 2, external to the centralized inventory system 1, object modifications likely to impact one or more of two given attributes of an electronic provider object, which may include, but is not limited to, an availability and/or a price of a hotel room.

Using availability and/or a price of a hotel room as non-limiting examples, by means of this man-machine interface 2, a hotelier can define the room types of their hotel, for example single or double room, an inventory of all his rooms, indicate availability and assign a price.

When changes are made to an electronic provider object (e.g. by hotelier), these object changes that may impact one or more of two given attributes of the electronic provider object are compacted 102 via aggregation means 3, and then stored 103 in a compacted form in a general database 4 external to the centralized inventory system 1. This compact form then allows for faster and more efficient processing of the data in the general database 4.

The method 100 includes the steps, performed by a receiving module 5 of the centralized inventory system 1, of:
receiving 104 object changes that may impact one or more of two given attributes of an electronic provider object, and then
placing 105 the object changes in a first queue Q1.

Then, periodically, according to a first period, the method 100 includes a step, performed by an impact calculation module 6 of the centralized inventory system 1, of merging 106 multiple object changes from the first queue Q1 by change category.

According to a non-limiting example, the first period may be between 8 and 12 seconds, and may typically be 10 seconds.

For example, a change related to a hotel closure is part of the hotel category while a change related to a price is part of a price list category.

This merging by category advantageously reduces the number of queries to be processed.

For each category of change, the method 100 comprises a step, executed by the impact calculation module 6, of determining an impact of the merged object modifications on a set of data pairs of the general database 4 external to the centralized inventory system 1, each data pair being formed by the two given attributes of an electronic provider object (e.g. a price and an availability of a hotel room). Furthermore, herein, the terms “modification” and “change” may be used interchangeably to refer to a modification and/or change to an electronic provider object and/or a modification and/or change to one or more attributes of an electronic provider object.

A priori, when a change (e.g. a modification) takes place on a rate grid of a non-partner electronic provider object inventory platform (e.g. a non-partner hotel room reservation platform), this modification and/or change should not be processed. Nevertheless, a modification of a rate schedule of a non-partner electronic provider object inventory platform may have an indirect impact on a rate schedule of a partner electronic provider object inventory platform (e.g. a partner hotel room reservation platform). This step 107 thus verifies the impacts of each modification and/or change.

The method 100 then includes a step, performed by the impact calculation module 6, of placing 108 each impacted data pair in a second queue Q2.

Then, as an impacted data pair arrives in the second queue Q2, the method 100 comprises a step, executed via an availability module 7 of the centralized inventory system 1, of determining 109, an update of the price and/or availability over a second predetermined period via a query to the general database 4.

According to a non-limiting example, the second predetermined period may be between 15 days and 45 days, and may typically be one month.

In a particular example of two given attributes of an electronic provider object, effectively, a price and/or availability modification of a hotel room may result in price and/or availability modifications of several hotel rooms over a period of one month.

The method 100 then includes a step, performed via a comparison module 8 of the centralized inventory system 1, of comparing 110 a hash value of the update of a data pair with a hash value of a corresponding data pair previously stored in a database 9 of the centralized inventory system 1.

According to a non-limiting example, when a difference between the hash value of the data pair update and the hash value of a corresponding data pair is detected, the method 100 comprises a step, performed via a transmission module 10 of the centralized inventory system 1, of transmitting 111 the data pair update to a partner hotel room inventory platform 11.

According to another non-limiting example, when a difference between the hash value of the data pair update and the hash value of a corresponding data pair is detected, the method 100 comprises a step, performed via the database 9 of the centralized inventory system 1, of storing 112 the hash value of the data pair update in the database 9 of the centralized inventory system 1.

According to another non-limiting example, when a difference between the hash value of the update of a data pair and the hash value of a corresponding data pair is detected, the method 100 comprises a step, executed via the database 9 of the centralized inventory system 1, of recording 113 an update indicator in the database 9 of the centralized inventory system 1.

In this non-limiting example, the method 100 comprises the steps, performed by the database 9 of the centralized inventory system 1, of:
receiving 114, from a partner electronic provider object inventory platform 12 (e.g. hotel room inventory platform), periodically according to a third predetermined period an update request;
If an update flag is stored in the database 9 of the centralized inventory system 1, transmits 115 the update flag to the partner electronic provider object inventory platform 12. Thereafter, the external partner electronic provider object inventory platform 12 is able to retrieve the update detail directly from the general database 4.

The various aspects of the present specification discussed above have many advantages. These include:
Synchronizing of electronic provider object data (e.g. hotel room update data);
Increasing the scalability of the centralized inventory system 1; and
Reducing the hardware resource consumption of the centralized inventory system 1.

As should by now be apparent, the operations and functions of the devices described herein are sufficiently complex as to require their implementation on a computer system, and cannot be performed, as a practical matter, in the human mind. In particular, computing devices, and the like, such as set forth herein are understood as requiring and providing speed and accuracy and complexity management that are not obtainable by human mental steps, in addition to the inherently digital nature of such operations.

In this specification, elements may be described as performing one or more functions. In general, an element that is configured to perform or configured for performing a function is enabled to perform the function, or is suitable for performing the function, or is adapted to perform the function, or is operable to perform the function, or is otherwise capable of performing the function.

The terms “about”, “substantially”, “essentially”, “approximately”, and the like, are defined as being “close to”, for example as understood by persons of skill in the art. In some examples, the terms are understood to be “within 10%,” in other examples, “within 5%”, in yet further examples, “within 1%”, and in yet further examples “within 0.5%”.

It is understood that for the purpose of this specification, language of “at least one of X, Y, and Z” and “one or more of X, Y and Z” can be construed as X only, Y only, Z only, or any combination of two or more items X, Y, and Z (e.g., XYZ, XY, YZ, XZ, and the like). Similar logic can be applied for two or more items in any occurrence of “at least one . . . ” and “one or more . . . ” language.

Unless the context of usage unambiguously indicates otherwise, articles “a,” “an,” and “the” should not be interpreted as meaning “one” or “only one.” Rather such articles should be interpreted as meaning “at least one” or “one or more.” Similarly, when the terms “the” or “said” are used to refer to a noun previously introduced by the indefinite article “a” or “an.” “the” and “said” mean “at least one” or “one or more” unless the usage unambiguously indicates otherwise.

Persons skilled in the art will appreciate that in some examples, the functionality

of devices and/or methods and/or processes described herein can be implemented using pre-programmed hardware or firmware elements (e.g., application specific integrated circuits (ASICs), electrically erasable programmable read-only memories (EEPROMs), etc.), or other related components. In other examples, the functionality of the devices and/or methods and/or processes described herein can be achieved using a computing apparatus that has access to a code memory (not shown), which stores computer-readable program code for operation of the computing apparatus. The computer-readable program code could be stored on a computer readable storage medium, which is fixed, tangible and readable directly by these components, (e.g., removable diskette, CD-ROM, ROM, fixed disk, USB drive). Furthermore, it is appreciated that the computer-readable program can be stored as a computer program product comprising a computer usable medium. Further, a persistent storage device can comprise the computer readable program code. It is yet further appreciated that the computer-readable program code and/or computer usable medium can comprise a non-transitory computer-readable program code and/or non-transitory computer usable medium. Alternatively, the computer-readable program code could be stored remotely but transmittable to these components via a modem or other interface device connected to a network (including, without limitation, the Internet) over a transmission medium. The transmission medium can be either a non-mobile medium (e.g., optical and/or digital and/or analog communications lines) or a mobile medium (e.g., microwave, infrared, free-space optical or other transmission schemes) or a combination thereof.

Persons skilled in the art will appreciate that there are yet more alternative examples and modifications possible, and that the above examples are only illustrations of one or more examples. The scope, therefore, is only to be limited by the claims appended hereto.

1. A method, performed by a centralized inventory system, for centrally updating an inventory of electronic provider objects, the method comprising:
receiving object changes that impact one or more of two given attributes of an electronic provider object;
placing the object changes in a first queue;
merging a plurality of object changes from the first queue by change category;
for each change category, determining an impact of the merged object changes on a set of data pairs of a general database external to the centralized inventory system, each data pair being formed by the two given attributes;
placing each impacted data pair in a second queue determining, for each impacted data pair, an update of one or more of the two given attributes over a second predetermined period via a query to the general database;
comparing a hash value of the update of a data pair with a hash value of a corresponding data pair previously stored in a database of the central inventory system;
when a difference between the hash value of the update of a data pair and the hash value of a corresponding data pair is detected, one or more of:
transmitting the data pair update to an electronic provider object inventory platform; and
recording the hash value of the data pair update in the database of the centralized inventory system.

2. The method according to claim 1, wherein when a difference between the hash value of the update of a data pair and the hash value of a corresponding data pair is detected, the method comprises a step of recording an update indicator in the database of the centralized inventory system.

3. The method according to claim 1, the method further comprising:
receiving, from the electronic provider object inventory platform, periodically according to a third predetermined period, an update request;
when an update flag is recorded in the database of the centralized inventory system, transmitting the update flag to the electronic provider object inventory platform.

4. The method according to claim, wherein merging (106) a plurality of object changes from the first queue by change categories is performed periodically according to a first predetermined period.

5. The method of claim 4, wherein the first predetermined period is between 8 and 12 seconds.

6. A method according to claim 1, wherein the second predetermined period is between 15 days and 45 days.

7. Method according to claim 1, further comprising:
performing, via a man-machine interface, the object changes likely to impact one or more of the two given attributes;
compacting, via aggregation means, the object changes likely to impact one or more of the two given attributes; and
recording the compacted changes in the general database.

8. A computer program product that is one or more of downloadable from a communication network, stored on a computer-readable medium, and executable by a processor, wherein the computer program product comprises program code instructions for implementing the method according to claim 1, when the program is executed on a computer.

9. A centralized electronic provider object inventory system, the centralized electronic provider object inventory system comprising a memory storing the computer program product according to the claim 8.
